(19) United States
(12) Patent Application Publication
(10) Pub. No.: US 2014/0197655 A1
(43) Pub. Date: Jul. 17, 2014

(54) VEHICLE WITH ROTATING SLIDE-OUT ROOM

(71) Applicant: Kent Stichter, New Paris, IN (US)

(72) Inventor: Kent Stichter, New Paris, IN (US)

(21) Appl. No.: 14/149,191

(22) Filed: Jan. 7, 2014

Related U.S. Application Data
(60) Provisional application No. 61/848,751, filed on Jan. 11, 2013.

(51) Int. Cl. B60P 3/34

(52) U.S. Cl. CPC B60P 3/34
USPC 296/26.15

(57) ABSTRACT

The present disclosure relates to systems and methods a rotatable slide-out room for a motor homes, recreational vehicles, campers, or trailers. The slide-out room is configured to rotate about a rotational axis into and out an aperture in the sidewall of the vehicle. When the slide-out room is in the closed position, it is positioned within the vehicle forming a continuous sidewall for the vehicle. When the slide-out room is opened, it extends out from the sidewall at the rotational axis and creates additional space for the vehicle.

### PRIORITY

The invention claims priority to U.S. provisional application No. 61/848,751 filed on Jan. 11, 2013.

### BACKGROUND

Towable and motorized vehicles, such as a motor homes, recreational vehicles, campers, or trailers are commonly used to provide temporary living quarters or workspace when traveling. Extendable or slide-out rooms can be included in these vehicles in order to increase the available interior space. Typically, a slide-out room is retracted into the interior space of the vehicle when the vehicle is in transit and expanded out when the vehicle is parked at its destination.

In order to increase the available interior space of a towable or motorized vehicle such as a motor home, recreational vehicle, camper, or trailer, slide-out rooms can be made an integral part of the design and construction. While the vehicle is in transit, the rotating slide-out room is retracted into the interior space of the vehicle. There is adequate space within the interior of the vehicle to accommodate the rotating slide-out room while the vehicle is in transit. When the vehicle is parked, the slide-out room is extended outward through an opening in the sidewall of the vehicle, increasing the interior accommodations.

Currently used designs for slide-out rooms suffer from several significant drawbacks. Slide-out rooms project perpendicularly from a side of the vehicle. This approach puts significant force on the extension mechanisms, which can cause them to be difficult to operate and unreliable, often needing repair. Because the walls of the slide-out room must be in the interior portion of the vehicle when retracted, the depth of the walls is limited.

Accordingly, there remains a need for improved slide-out rooms, which are dependable and provide sufficient interior space.

### SUMMARY

Disclosed herein are systems, devices, and methods for a vehicle with a rotating slide-out room. In certain aspects, the systems, devices, and methods include a vehicle having a fixed room and a rotating slide-out room. The fixed room has at least one sidewall, the sidewall having an aperture. The slide-out room is configured to rotate about a rotational axis into and out from the aperture.

The slide-out room has a first wall section with a first end rotatably coupled to the sidewall to form the rotational axis. The first wall section is effectively flush with the sidewall when the slide-out room is in the closed position, and extends out from the sidewall at the rotational axis when slide-out room is in the open position. The second wall section coupled to the first wall section at a second end opposite from the rotational axis, wherein the second wall section is positioned within the fixed room when the slide-out room is in the closed position, and extends out from the aperture and the sidewall when slide-out room is in the open position.

In certain embodiments, the second wall section is curved. For example, the second wall section may have a radius of curvature approximately equal to the length of the first wall section. In certain approaches, the rotational axis is approximately vertical. The first wall section may be rotatably coupled to the sidewall of the vehicle with at least one hinge. In certain approaches, the vehicle includes a motor coupled to the slide-out room and configured to rotate the slide-out room between the open position and closed position. For example, the motor may be coupled to the second wall portion.

In certain approaches, the vehicle has a first floor section and the slide-out room has a second floor section. The second floor section is above the first floor section when the slide-out room is in the closed position, and the second floor section is flush with the first floor section when the slide-out room is in the open position. The slide-out room may include a support jack coupled to the second floor section. In certain embodiments, the slide-out room has a roof section.

In certain embodiments, the first wall section includes a first stop at the coupling of the first wall section and second wall section. The first stop extends approximately parallel to the first wall section and approximately perpendicular to the second wall section, the first stop being configured to contact the sidewall of the vehicle such that the first wall section is approximately flush with the sidewall when the slide-out room is in the closed position. In certain approaches, the second wall section includes a second stop at an end opposite the coupling of the first wall section and second wall section. The second stop extends approximately perpendicular to the second wall section, the second stop being configured to contact the sidewall of the vehicle when the slide-out room is in the open position.

In certain approaches, the angle between the first wall section and the second wall section is acute. In certain approaches, the angle between the first wall section and the second wall section is at least 90 degrees.

These and other embodiments are described in more detail herein. Variations and modifications of these embodiments will occur to those of skill in the art after reviewing this disclosure. The foregoing features and aspects may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1a shows a perspective view of a vehicle with rotating slide-out rooms extended from the body of the fixed room; and

FIG. 1b shows a perspective view of a vehicle with rotating slide-out rooms with a straight wall; and

FIG. 2 shows a perspective view of the vehicle with the rotating slide-out rooms retracted for transit or storage; and

FIG. 3 is a top plan view showing the rotating slide-out rooms retracted within the vehicle's interior space for transit or storage; and

FIG. 4 is a top plan view showing the rotating slide-out rooms extended outside the vehicle's interior space; and

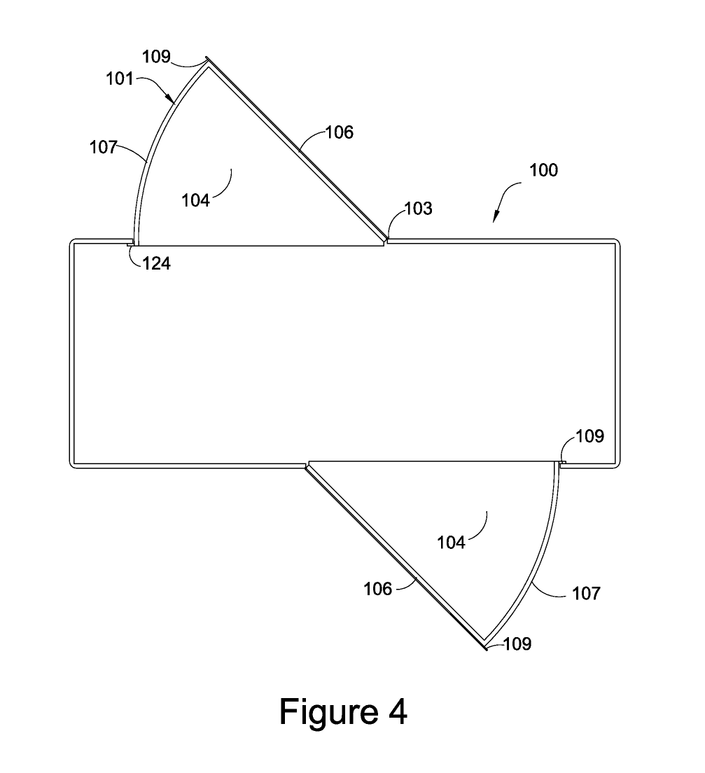

FIG. 5 depicts a slide-out room with a rotation mechanism.

### DETAILED DESCRIPTION

To provide an overall understanding of the systems, devices, and methods described herein, certain illustrative embodiments will be described. Although the embodiments and features described herein are specifically described for use in connection with slide-out rooms for recreational vehicles, motor homes, and trailer systems, it will be understood that all the components, connection mechanisms, adjustable systems, manufacturing methods, and other features outlined below may be combined with one another in any suitable manner and may be adapted and applied to other systems and processes, including, but not limited temporary or permanent buildings, storage areas, and furniture.

Disclosed herein are systems, devices, and methods for a vehicle with a rotating slide-out room. In certain aspects, the systems, devices, and methods include a vehicle having a fixed room and a rotating slide-out room. The fixed room has at least one sidewall, the sidewall having an aperture. The slide-out room is configured to rotate about a rotational axis into and out from the aperture. The slide-out room has a first wall section with a first end rotatably coupled to the sidewall to form the rotational axis. The first wall section is effectively flush with the sidewall when the slide-out room is in the closed position, and extends out from the sidewall at the rotational axis when slide-out room is in the open position. The second wall section coupled to the first wall section at a second end opposite from the rotational axis, wherein the second wall section is positioned within the fixed room when the slide-out room is in the closed position, and extends out from the aperture and the sidewall when slide-out room is in the open position.

A rotating slide-out room provides particular advantages, such as new layout possibilities for vehicles. The current slide-out rooms that are prevalent in the vehicle industry are all square or rectangle in shape. The result is plan layouts for living spaces, utility spaces, storage spaces, and sleeping spaces are all rectilinear in design. The rotating slide-out room changes the interior plan layout that is currently available. The rotating slide-out room also changes the exterior appearance of the vehicle when the room is extended. In certain approaches, rotating slide-out room provides improved stability since a portion of the wall is coupled directly to the vehicle along a rotational pivot axis as described in further detail below.

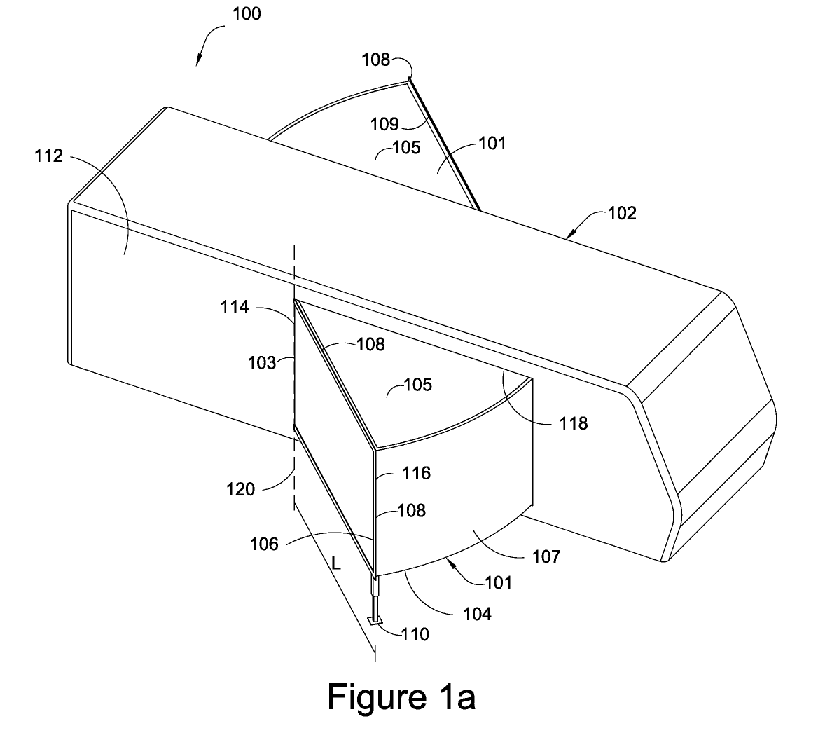

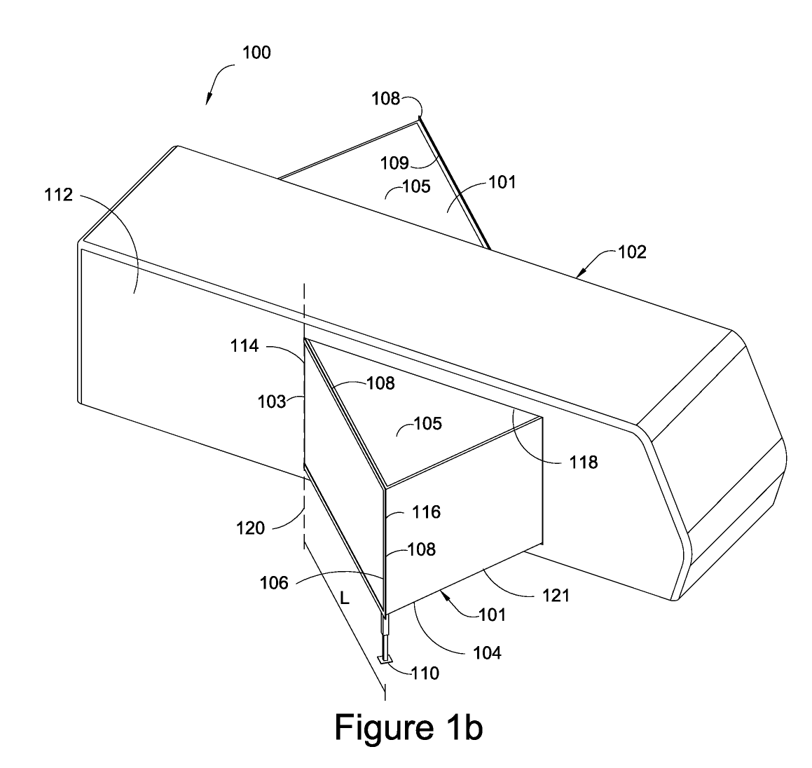

FIG. 1 a shows a perspective view of a vehicle with rotating slide-out rooms extended from the body of the fixed room. The vehicle 100 includes a fixed room 102 and at least one rotating slide-out room 101 that extends and retracts relative to fixed room 102 by pivoting about a vertical rotation axis 120. Vehicle 100 may be a motor home, recreational vehicle, camper, truck, or trailer. Slide-out room 101 pivots through aperture 118 of vehicle 100. Slide-out room 101 includes a floor section 104, a roof section 105, a first wall section 106, and a second wall section 107. First wall section 106 includes a pivot end 114 and a retracting end 116. Pivot end 114 is rotatably coupled to vehicle sidewall 112 of vehicle 100 to form rotation axis 120. For example, in certain approaches, pivot end 114 is coupled to wall 112 with hinge 103.

Retracting end 116 couples with second wall section 107. In certain approaches, second wall section 107 is curved. For example, second wall section 107 may have a radius of curvature approximately equal to the length of the first wall section. In this case, the length “L” of the first wall section is defined as the length of the wall in the direction between rotation axis 120 and retracting end 116. The curvature of wall section 107 allows for ease in rotating room 101 into and out of vehicle 100 since as the slide-out room rotates or pivots out, a curved wall section 107 will go through aperture 118 at approximately the same place throughout the entire slide-out process.

In certain embodiments, the second wall section is straight. For example, FIG. 1b depicts a straight second wall section 121. Straight second wall section 121 may provide simpler placement of furniture along second wall section 121. Straight second wall section 121 also can be advantageous for manufacturing purposes, making vehicle 100 simpler to produce. Although second wall section has been depicted as having a circular segment shape or linear shape, any appropriate shape may be used.

In certain approaches, retracting end 116 and second wall section 107 or 121 are fixedly coupled. Additionally or alternatively, end 116 and wall section 107 or 121 may be rotatably coupled. For example, a rotatable coupling, such as a hinge, may be used to allow slide-out room 101 to expand or contract, and then wall section 107 or 121 may be locked into place.

First wall section 106 and second wall section 107 or 121 may be coupled at any appropriate angle. In certain approaches, the angle between first wall section 106 and second wall section 107 or 121 is acute. In certain approaches, the angle between first wall section 106 and second wall section 107 or 121 is a right angle. In certain approaches, the angle between first wall section 106 and second wall section 107 or 121 is obtuse. Additionally or alternatively, the angles between vehicle wall 112 and first wall section 106 in the open or expanded position may be any appropriate angle. In certain approaches, the angle between vehicle wall 112 and first wall section 106 is acute. In certain approaches, the angle between vehicle wall 112 and first wall section 106 is a right angle. In certain approaches, the angle between vehicle wall 112 and first wall section 106 is obtuse. In certain approaches, slide-out room 101 opens into a semi-circular room with first wall section 106 being approximately parallel with vehicle wall 112. Additionally or alternatively, the angles between vehicle wall 112 and second wall section 107 or 121 in the open or expanded position may be any appropriate angle. In certain approaches, the angle between vehicle wall 112 and second wall section 107 or 121 is acute. In certain approaches, the angle between vehicle wall 112 and second wall section 107 or 121 is a right angle. In certain approaches, the angle between vehicle wall 112 and second wall section 107 or 121 is obtuse.

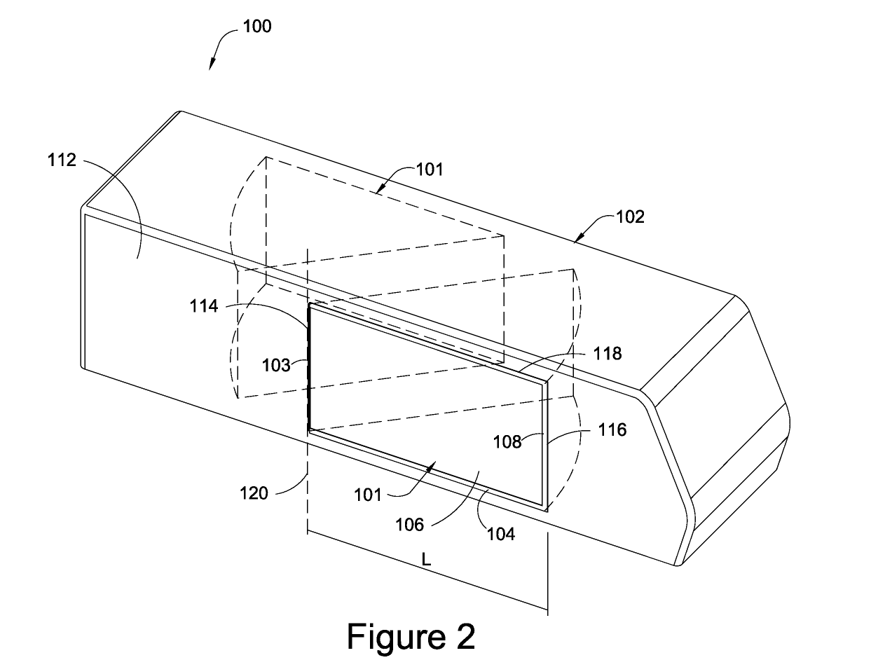

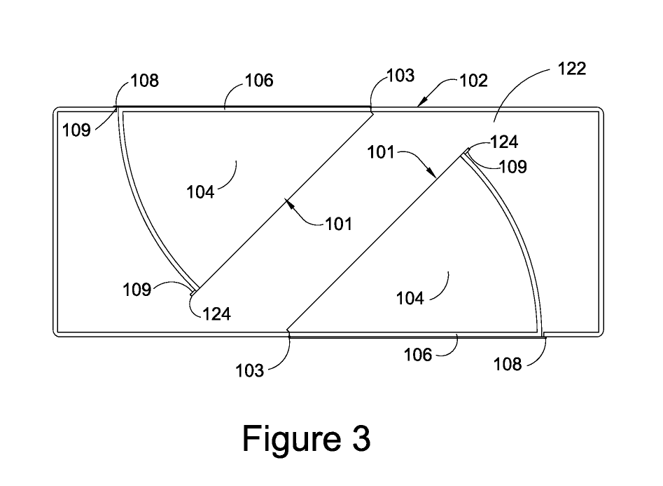

As depicted in FIG. 2 and FIG. 3, when room 101 is in the closed or retracted position, first wall section 106 is continuous and effectively flush with vehicle wall 112. This closed position is typically used when vehicle 100 is in transit, in storage, or when the additional space provided by slide-out room 100 is otherwise not needed.

Since the rotating slide-out room 101 is nested within a portion of the fixed room 102, in certain embodiments, slide-out room 101 is dimensioned smaller than the fixed room 102. When in the closed position, floor section 104 of the pivoting slide-out room 101 rests above or on top of floor section 122 of fixed room 102 of vehicle 100. In this position, floor section 104 is usable floor space for vehicle 100.

In certain approaches, when rotating slide-out room 101 is in an the extended or open position, floor section 104 remains higher than floor section 122 of fixed room 102. Such stepped flooring has frequently been found to be undesirable, inconvenient, and may be hazardous. The step also limits the positioning of furniture within the room, and the step makes it difficult to create an aesthetically pleasing floor appearance. Accordingly, in certain approaches, floor section 104 of slide-out room 101 is approximately flush with floor section 122 of fixed room 102 when slide-out room 101 is in the extended position. The rotating slide-out room 101 may be raised in the closed or retracted position and lowered in the open or extended position resulting in a flush floor.

In certain embodiments, at least one support jack 110 is used to support slide-out room 101 when in the extended position. Support jack 110 may be coupled directly to slide-out room 101. For example, support jack 110 may be coupled to floor section 104. In certain approaches, support jack 110 is foldable or collapsible. In certain approaches, support jack 110 rotates into slide-out room 101 when not in use. Additionally or alternatively, support jack 110 may be removably coupled to slide-out room 101. Support jack 110 may be detachable and/or stored elsewhere. Support jack 110 provides additional support for room 101 and helps prevent bouncing when a dynamic load is imposed on slide-out room 101. For example, bouncing can potentially occur when an occupant walks on floor section 104, which can be prevented through the use of support jack 110. In certain approaches, the support jack 110 has an adjustable height. The adjustable height allows for adjustments to appropriately support slide-out room 101 based on the terrain where vehicle 100 is resting.

In certain embodiments, slide-out room 101 includes stops to enable proper positioning of slide-out room in the open and closed positions. For example, first wall section 106 may include one or more stops 108 along edge 116. Stop 108 may extend approximately parallel to first wall section 106 and approximately perpendicular to second wall section 107. Similarly, first wall section 106 may include a stop 108 along the upper roof edge which extends approximately parallel to first wall section 106 and approximately perpendicular to roof section 105. In certain approaches, first wall section 106 may include a stop 108 along the lower floor edge which extends approximately parallel to first wall section 106 and approximately perpendicular to floor section 104. Stops 108 are used to position slide-out room 101 within vehicle 100 and prevent slide-out room 101 from extending too far through aperture 118 and into vehicle 100. Stops 108 contact the exterior of vehicle wall 112 in the closed position. Additionally, stops 108 position slide-out room 101 so that wall section 106 is approximately flush with vehicle wall 112 when in the closed position. In certain embodiments, stops 108 are L-shaped. Additionally or alternatively, slide-out room 101 may include one or more stops 124 along second wall section 107. Stop 124 may be perpendicular to second wall section 107 and run along the edge opposite end 116. Stops 124 are used to position slide-out room 101 and prevent slide-out room 101 from extending too far through aperture 118 and out of vehicle 100. Stops 124 contact the interior of vehicle wall 112 in the open position.

In certain approaches, stops 108 and 124 include weather sealing material 109. For example, the weather sealing material 109 may be a compressible strip form located on the abutting surface of stop 108, stop 124, or vehicle wall 112.

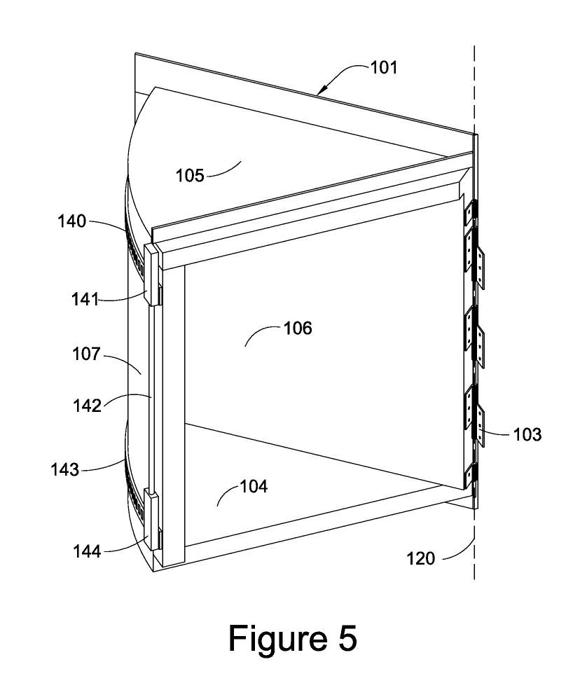

FIG. 5 depicts a slide-out room with a rotation mechanism. Rotating slide-out room 101 has a hinge 103 affixed to the vertical edge of aperture 118 in vehicle wall 112 of vehicle 100. In certain approaches, slide-out room 101 may include systems and assist devices such as a hand crank, electric motor crank, pneumatic and hydraulic system, or various combinations thereof. Additionally or alternatively, vehicle 100 may include a telescoping rail, cable system, roller wheels, and/or gear and rail that aids in the extension and retraction of rotating slide-out room 101. In certain embodiments, slide-out room 101 includes one or more gear rails, such as upper gear rail 140 and lower gear rail 143 along second wall portion 107. Gear rails 140 and 143 support and guide the rotation of slide-out room 101 as it pivots about rotation axis 120. Gear rails 140 and 143 may also be coupled to vehicle sidewall 112. In certain approaches, gear rails include motors, such as upper motor 141 coupled to gear rail 140 and lower motor 144 coupled to gear rail 143. Motors 141 and 144 assist, and in certain approaches, automate the rotation of slide-out room 101 to and from the open and closed positions. In certain embodiments, motors 141 and 144 are coupled with motor shaft 142. Motor shaft 142 synchronizes motors 141 and 144 to ensure proper rotation of slide-out room 101. In certain approaches, tracks, rails, and/or motor systems may be coupled to floor 104. For example, the underside of floor 104 may include roller wheels to aid in rotating slide-out room 101 between positions.

Slide-out room 101 may include additional features not explicitly depicted in the figures. In certain approaches, slide-out room 101 may include doors and/or windows. For example, doors and/or windows may be included in first wall portion 106 or second wall portion 107. In certain approaches, roof portion 105 and second wall portion 107 are collapsible. For example, roof portion 105 and wall portion 107 may be constructed of canvas or other collapsible or foldable material. In this way, wall portion 107 would not interfere with the interior layout of fixed room 102 when slide-out room 101 is in the closed position.

The foregoing is merely illustrative of the principles of the disclosure, and the systems, devices, and methods can be practiced by other than the described embodiments, which are presented for purposes of illustration and not of limitation. It is to be understood that the systems, devices, and methods disclosed herein, while shown for use for slide-out rooms for recreational vehicles, motor homes, and trailer systems, may be applied to systems, devices, and methods to be used in other fields of use, including, but not limited to, temporary or permanent buildings, homes, storage areas, and furniture. For example, freestanding buildings may include a rotatable slide-out rooms using the methods and systems described herein. Additionally, interior spaces in a building may utilize a rotatable slide-out space to provide additional space or alternative layouts. For example, a rotatable space may hide interior furniture, such as a bed, when not in use, but provide the ability to use the furniture at the appropriate times, thereby creating a multi-functional living space.

While several embodiments have been described that are exemplary of the present system and methods, one skilled in the art will recognize additional embodiments within the spirit and scope of the systems and methods described herein. Modification and variation can be made to the disclosed embodiments without departing from the scope of the disclosure. Those skilled in the art will appreciate that the applications of the embodiments disclosed herein are varied. Accordingly, additions and modifications can be made without departing from the principles of the disclosure. In this regard, it is intended that such changes would still fall within the scope of the disclosure. Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented. Therefore, this disclosure is not limited to particular embodiments, but is intended to cover modifications within the spirit and scope of the disclosure.

All references cited herein are incorporated by reference in their entirety and made part of this application.

What is claimed is:

1. A vehicle, comprising:
a fixed room with at least one sidewall, the sidewall having an aperture; and
a slide-out room configured to rotate about a rotational axis into and out from the aperture, the slide-out room having:
a first wall section having a first end rotatably coupled to the sidewall to form the rotational axis, wherein the first wall section is effectively flush with the sidewall when the slide-out room is in the closed position, and extends out from the sidewall at the rotational axis when slide-out room is in the open position; and
a second wall section coupled to the first wall section at a second end opposite from the rotational axis, wherein the second wall section is positioned within the fixed room when the slide-out room is in the closed position, and extends out from the aperture and the sidewall when slide-out room is in the open position.

2. The vehicle of claim 1, wherein the second wall section is curved.

3. The vehicle of claim 2, wherein the second wall section has a radius of curvature approximately equal to the length of the first wall section.

4. The vehicle of claim 1, wherein the rotational axis is approximately vertical.

5. The vehicle of claim 4, wherein the first wall section is rotatably coupled to the sidewall of the vehicle with at least one hinge.

6. The vehicle of claim 5, wherein the vehicle includes a motor coupled to the slide-out room and configured to rotate the slide-out room between the open position and closed position.

7. The vehicle of claim 6, wherein the motor is coupled to the second wall portion.

8. The vehicle of claim 1, wherein the vehicle has a first floor section and the slide-out room has a second floor section.

9. The vehicle of claim 7, wherein the second floor section is above the first floor section when the slide-out room is in the closed position, and the second floor section is flush with the first floor section when the slide-out room is in the open position.

10. The vehicle of claim 1, further comprising a support jack coupled to the second floor section.

11. The vehicle of claim 1, wherein the slide-out room has a roof section.

12. The vehicle of claim 1, wherein the first wall section includes a first stop at the coupling of the first wall section and second wall section.

13. The vehicle of claim 12, wherein the first stop extends approximately parallel to the first wall section and approximately perpendicular to the second wall section, the first stop being configured to contact the sidewall of the vehicle such that the first wall section is approximately flush with the sidewall when the slide-out room is in the closed position.

14. The vehicle of claim 13, wherein the second wall section includes a second stop at an end opposite the coupling of the first wall section and second wall section.

15. The vehicle of claim 14, wherein the second stop extends approximately perpendicular to the second wall section, the second stop being configured to contact the sidewall of the vehicle when the slide-out room is in the open position.

16. The vehicle of claim 1, wherein the angle between the first wall section and the second wall section is acute.

17. The vehicle of claim 1, wherein the angle between the first wall section and the second wall section is at least 90 degrees.
